(19) United States
(12) Patent Application Publication
(10) Pub. No.: US 2026/0278513 A1
(43) Pub. Date: Sep. 17, 2026

(54) MACHINE LEARNING MODEL AUTOMATED ANAMOLY DETECTION

(71) Applicant: INTUIT INC., Mountain View, CA (US)

(72) Inventors: Andrew Jacques CONEGLIANO, San Francisco, CA (US); Bin LI, San Jose, CA (US); Atanu ROY, Dublin, CA (US); Victor Jayaseelan SAVARIMUTHU, Santa Clara, CA (US); Peter Benjamin TWIEG, San Jose, CA (US)

(21) Appl. No.: 19/078,878

(22) Filed: Mar. 13, 2025

(51) Int. Cl. G06Q 10/0639; G06Q 30/018; G06Q 40/06

(52) U.S. Cl. CPC G06Q 10/06393; G06Q 30/0185; G06Q 40/06

(57) ABSTRACT

Aspects of the present disclosure relate to automatically detecting and classifying anomalies using machine learning models. Embodiments include identifying, from a plurality of entities, one or more particular entities of interest based on instructions provided to a machine learning model along with features of the plurality of entities, wherein the one or more particular entities of interest does not include at least one entity in the plurality of entities. Embodiments include assigning each particular entity of interest to one or more groups based on a set of attributes associated with the particular entity. Embodiments include analyzing the one or more groups based on one or more characteristics extracted from each group of the one or more groups. Embodiments include generating an action probability score for each group based on the analyzing. Embodiments include providing an output based on the action probability score and performing an action based on the output.

### INTRODUCTION

Aspects of the present disclosure relate to techniques for automatically detecting and classifying anomalies using machine learning models. In particular, techniques described herein involve automatically identifying anomalies within a plurality of entities, clustering the anomalies into groups based on certain attributes associated with each anomaly, scoring each group based on its respective characteristics, and generating an output based on the score for each group.

### BACKGROUND

Every year, millions of people, businesses, and organizations around the world use software applications to assist with countless aspects of life. Because of this, software applications are increasingly the target of fraudulent activity. When that fraud is successful, sensitive data, including financial, personal, and otherwise, may be compromised or at risk. Such a breach may have lasting, personal impacts on individuals, and global ramifications for a company. Attacks against and within software applications may be orchestrated by an individual or, more increasingly, by a group of people working in concert. Large groups dedicated to committing fraudulent activity pose a particularly grave risk of harm, as organized groups are able to more quickly and more extensively infiltrate a system and siphon off vast amounts of sensitive data, by attacking numerous transactions, accounts, and/or merchants nearly simultaneously. Existing techniques fail to address the large-scale nature of the attacks from these organized groups. For example, current systems are limited to processing only small numbers of transactions and/or accounts, as well as limited to processing entities at a single level (e.g. only transactions, only accounts, etc.). Additionally, existing techniques that process larger amounts of data are inefficient and inaccurate, leading to high computational costs as well as missed fraudulent activity and activity falsely labeled as fraudulent.

Thus, there is a need in the art for improved techniques for automatically detecting fraudulent activity.

### BRIEF SUMMARY

Certain embodiments provide a method of automatically detecting and classifying anomalies using machine learning models. The method generally includes: identifying, from a plurality of entities, one or more particular entities of interest based on instructions provided to a machine learning model along with features of the plurality of entities, wherein the one or more particular entities of interest does not include at least one entity in the plurality of entities; assigning each particular entity of the one or more particular entities of interest to one or more groups based on a set of attributes associated with the particular entity; analyzing the one or more groups based on one or more characteristics extracted from each group of the one or more groups; generating an action probability score for each group of the one or more groups based on the analyzing; providing an output based on the action probability score; and performing an action based on the output.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of workflow related to automatically detecting and classifying anomalies using machine learning models.

FIG. 2 depicts an additional example of workflow related to automatically detecting and classifying anomalies using machine learning models.

FIG. 3 is a block diagram illustrating an example related to automatically detecting and classifying anomalies using machine learning models.

FIG. 4 depicts example operations related to automatically detecting and classifying anomalies using machine learning models.

FIG. 5 depicts an example of a processing system for automatically detecting and classifying anomalies using machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically detecting and classifying anomalies using machine learning models.

Fraud poses an increasingly large threat to individual and institutional data privacy and security. The risk is heightened further when organized groups of people work together to perpetrate this fraud much more quickly and on a much larger scale, compromising vast amounts of sensitive personal and/or financial data. Current techniques for detecting this fraud (and then mitigating it) do not address the multi-faceted nature of the concerted attacks and are thus limited to smaller amounts and/or types of data. As a result, those techniques are inefficient and inaccurate. To improve automated fraud detection, techniques described herein employ machine learning models to automatically identify anomalies (i.e., indicative of fraud) in a set of input data, cluster the identified anomalies into groups based on associated attributes, score each of the groups by analyzing their features, and provide an output based on the scoring. Such techniques result in an automated process for fraud detection that is more efficient, more accurate, and more thorough, improving downstream fraud prevention and mitigation. For example, a machine learning model, such as a language processing machine learning model, may be instructed to identify anomalies in a plurality of entities. The language processing machine learning model may, for instance, be a large language model capable of processing natural language inputs and generating natural language outputs. The entities may consist of one or more transactions, accounts, merchants, or a combination thereof. An anomaly may be an entity that possesses one or more indicators of potential fraud. For example, a transaction containing a suspicious amount, vendor, timestamp, and/or the like may be deemed risky. The model may also identify features of the plurality of entities, such as features at the transaction level (e.g., purchase details) and/or features at the account level (e.g., deposit and/or withdrawal information) based on multiple transactions associated with each account. During the identification process, a particular entity may be flagged by a model trained to detect an entity that differs from other entities in one or more aspects. For example, a “bad” transaction may be flagged because it deviates from one or more characteristics known by the model to be associated with a set of “good” transactions. A “bad” transaction may also be flagged if it shares certain characteristics known by the model to be indicative of “bad” transactions. Those characteristics may correspond to the aforementioned risk features such as transaction amount, date and time, vendor, etc.

Once identified, each anomaly may be assigned to one or more groups based on attributes of that anomaly. For example, an anomaly may be assigned to a group based on certain features identified above (i.e., during the risk identification process) and/or other features such as account profiles (e.g., phone number, address, account type, account history, etc.). The assigning may be based on a graph-based clustering algorithm, a distance-based clustering algorithm, and/or the like. As a result of the clustering, singular instances of possible fraud are excluded, while the dangerous coordinated fraudulent activity (i.e., the type perpetrated by the fraud groups) is retained and prioritized for further analysis and prevention.

Each group may then be analyzed based on characteristics extracted from that particular group. For example, characteristics may include historical data associated with each group of anomalies, such as location, industry, transaction volume, transaction history and/or account history, among others. An action probability score may then be generated for each group based on the extracted characteristics. The action probability score may represent a level and/or amount of risk associated with the particular group. An output may be provided based on the action probability score. For example, an alert may be created if the action probability score exceeds a threshold value. A group with a score exceeding the threshold value may, for instance, have a high likelihood that fraudulent activity has occurred or is occurring and that immediate, remedial action must be taken. An action may be performed based on the output, such as displaying the output on a user interface or sending the output to one or more elements of a software application. A support technician, for instance, may then prevent any remaining fraud, secure the account, restore user access (i.e., if they were locked out), and/or the like.

Embodiments of the present disclosure provide numerous technical and practical effects and benefits. As noted above, swift and accurate fraud detection is imperative in maintaining secure, operational, and trustworthy software applications. Existing techniques for fraud detection, however, are limited in their processing capabilities and, as a result, are inefficient and/or inaccurate. The result is undetected fraudulent activity which causes more data to be compromised while also increasing costs to both implement more protections and to mitigate the loss of the sensitive data once the damage is done. Additionally, unnecessary resources are expended when an entity is falsely labeled as fraudulent. The present disclosure solves these technical problems. Techniques described herein ensure accurate and efficient fraud detection through a particular process that involves automatically identifying and categorizing anomalies in a plurality of entities provided to a machine learning model, along with generating a response based on scoring the categorized anomalies. This significantly decreases the time and resources needed for fraud detection, while at the same time drastically improving the accuracy of rooting out fraudulent activity committed by large, organized groups of people. Chiefly, by first using a machine learning model to identify and extracting anomalies from a large plurality of entities of varying type (i.e., transactions, accounts, and merchants) and then clustering such anomalous entities into groups, techniques described herein are not only more accurate and efficient (i.e., compared to performing clustering on the entire population of entities and/or on only one type of entity, which would take longer and result in more errors), but also are better suited to detect patterns indicative of a coordinated effort, which pose the greatest threat of harm to individuals and organizations. Additionally, by analyzing the groups of anomalous entities, such as based on historical data (i.e., tracking one or more features and how they change over time), fast-moving fraud (that may otherwise go unnoticed and/or unchecked) may be automatically detected and stopped, in a manner not possible with prior techniques, before sensitive data is compromised. These techniques not only save resources during the fraud detection, but they also save resources that would otherwise be expended due to delayed detection and/or errors in the detection by reducing the time for identification and detection as well as reducing false positives and false negatives.

### Example Workflows Related to Automatically Detecting and Classifying Anomalies Using Machine Learning Models

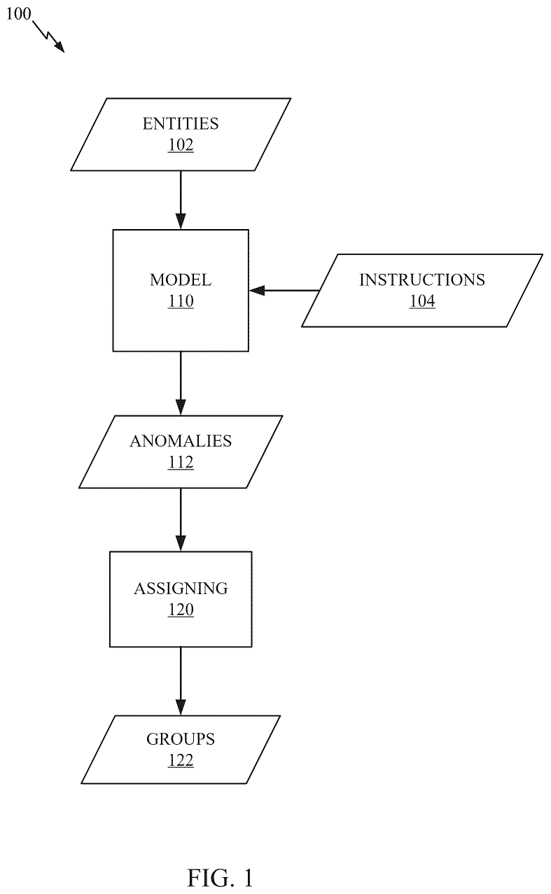

FIG. 1 depicts an example workflow 100 related to automatically detecting and classifying anomalies using machine learning models. For example, workflow 100 may represent a series of steps associated with identifying and clustering anomalies identified in a plurality of entities.

A model 110 may comprise a machine learning model. In a particular example, model 110 is a language processing machine learning model such as a large language model (LLM). For example, model 110 may have been trained on a large training data set in order to process natural language inputs and generate natural language content in response. In some embodiments, model 110 is a generative pre-trained transformer (GPT) model that has been trained on a large set of training data (e.g., across a plurality of domains), and is capable as a result of such training to perform a wide variety of language-related tasks in response to natural language prompts. In some embodiments, model 110 has been fine-tuned for one or more particular domains, such as for use with a particular software application or for a specific purpose, while in other embodiments model 110 has been trained in a more general fashion and has not been fine-tuned in such a manner. Model 110 may have a large number of tunable parameters, which are iteratively adjusted during a model training process based on training data. In alternative embodiments, model 110 may be another type of machine learning model that is capable of generating content. For example, model 110 may be a generative adversarial network (GAN), an autoencoder model, an autoregressive model, a diffusion model, a Bayesian network, a hidden Markov model, and/or the like.

The model 110 may receive entities 102 and instructions 104. The entities 102 may comprise a plurality of entities consisting of one or more transactions, accounts, merchants, or a combination thereof. The instructions 104 may contain natural language, code language, or a combination thereof. The instructions 104 may further include steps for the model 110 to follow, a description of attributes to evaluate and features to extract during the identification process, one or more characteristics to be analyzed and used to cluster the anomalies, and/or information to be used during the scoring and output generation processes (e.g., a scale and/or threshold value). Based on the instructions, the model 110 may identify one or more anomalies (i.e., entities that are outliers) in the plurality of entities 102. A transaction containing a suspicious amount, vendor, timestamp, and/or the like may be deemed risky. For example, a transaction with a timestamp of 2:00 AM may be an anomaly compared to other transactions all having a timestamp between 6:00 AM and 11:00 PM. Likewise, an account with three transactions in a row to a vendor never used before may be an anomaly. In addition to identifying the anomalies 112, features associated with the entities may also be identified both at the transaction level (e.g., purchase details) and/or features at the account level (e.g., deposit and/or withdrawal information) based on multiple transactions associated with each account.

In some embodiments, the identifying may comprise flagging the one or more anomalies using a model trained on labeled training data (e.g., using a supervised learning process) to detect entities in the plurality of entities with one or more features associated with labels in the labeled training data. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For example, labels may correspond to one or more risk features described above (e.g., certain amounts, vendors, timestamps, etc.) and, during the identification process, the model may flag one or more entities that have those features corresponding to the labels. In other embodiments, the identifying may comprise flagging the one or more anomalies using a model trained on unlabeled training data (e.g., using an unsupervised learning process) to detect entities in the plurality of entities greater than a threshold distance from a baseline set of entities. For example, an encoder model, trained on “good” transactions and/or accounts (i.e., those with a certain set of attributes not associated with fraudulent activity), may be used to identify a “bad” transaction and/or account more than a specified distance away from the “good” ones (which is indicative that there might be fraud present). In another example, the encoder model may additionally or alternatively be trained on “bad” transactions and/or accounts (i.e., those with a certain set of attributes especially associated with fraudulent activity) and may be used to identify a “bad” transaction and/or account less than a specified distance away from other “bad” ones (also indicative that there might be fraud present). Other unsupervised techniques include using an isolation forest, local outlier factor, and/or the like. The result is a set of anomalies 112 that is smaller than the original plurality of entities 102 and that may be passed on for further processing.

Once the anomalies 112 are collected from the entities 102, the anomalies 112 may then be assigned, during assigning 120, to one or more groups 122 based on attributes associated with each particular entity. The attributes may comprise risk features identified above as well as account profile features, such as phone numbers, addresses, account numbers, transaction history, and/or the like. For example, flagged transactions (or accounts containing one or more such transactions) with similar timestamps and/or with similar vendors may be grouped together. The assigning may comprise utilizing a graph-based clustering algorithm, a distance-based clustering algorithm, and/or the like. For example, the anomalies 112 may be assigned to groups 122 using K-means clustering. K-means clustering may refer to a process by which a number of centroids are created in unlabeled data and each data point is matched to the nearest centroid (e.g., based on a Euclidean distance). Each group of groups 122 may comprise the data points (i.e., anomalies) assigned to the corresponding centroid. By creating the groups 122 in this way, analyzing and scoring will occur on only those entities identified as potentially susceptible to fraud, which reduces the processing time and resources needed to detect the fraud as well as improves accuracy, especially when detecting coordinated fraud efforts.

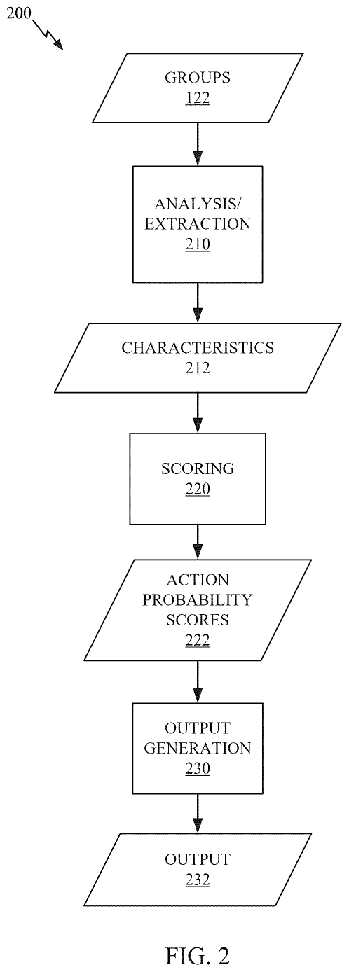

FIG. 2 depicts an additional example workflow 200 related to automatically detecting and classifying anomalies using machine learning models. In particular, FIG. 2 depicts a series of steps that may be performed subsequently to those of FIG. 1 in which an output is generated by analyzing and scoring groups of the clustered anomalies.

Once created (i.e., during one or more steps depicted in FIG. 1), groups 122 may undergo analysis/extraction 210. During analysis/extraction 210, groups 122 may be analyzed based on characteristics 212 extracted from each group of groups 122. Characteristics 212 may comprise one or more features of a group derived from the group as a whole and/or from the entities (e.g., transactions, accounts, etc.) contained in that group. For example, the characteristics 212 may include the cluster size of the group (i.e., based on the number of entities contained therein) as well as any combination of risk features (e.g., factors evaluated during the identification process as indicative of potential fraudulent activity), profile features (e.g., phone numbers, addresses, account numbers, and/or the like utilized during the assigning process), and/or reputation features (e.g., account closures, bank controls, etc.) of the entities within the group. Characteristics 212 may also comprise historical data associated with each group of groups 122. For example, certain features of merchants, such as the location, industry, transaction volume, and/or the like, may be tracked over time. A significant increase, for instance, in transaction volume and/or group size over a short period of time may indicate that fraudulent activity is occurring.

Next, based on the above characteristics 212, among others, the groups 122 are scored, during scoring 220, and each group is given an action probability score, collectively denoted action probability scores 222. An action probability score may be representative of the amount of risk associated with a particular group. For example, an action probability score of 8 (e.g., on a scale of 1-10) may indicate that it is very likely that there is a coordinated fraudulent attack occurring. A certain scale with which the groups 122 are scored may be provided in the instructions 104 to the model 110, and/or may comprise weighted parameters (i.e., a particular characteristic may be afforded more importance than another during scoring 220 via a relatively higher weight). The scoring 220 may be performed more than once for a particular group of groups 122, such as daily, to account for ongoing updates (e.g., the group size and transaction volume increase from above may cause a score to rise from a 3 to a 7, indicating that fraud is much more likely occurring and action must be taken), rendering the process more dynamic.

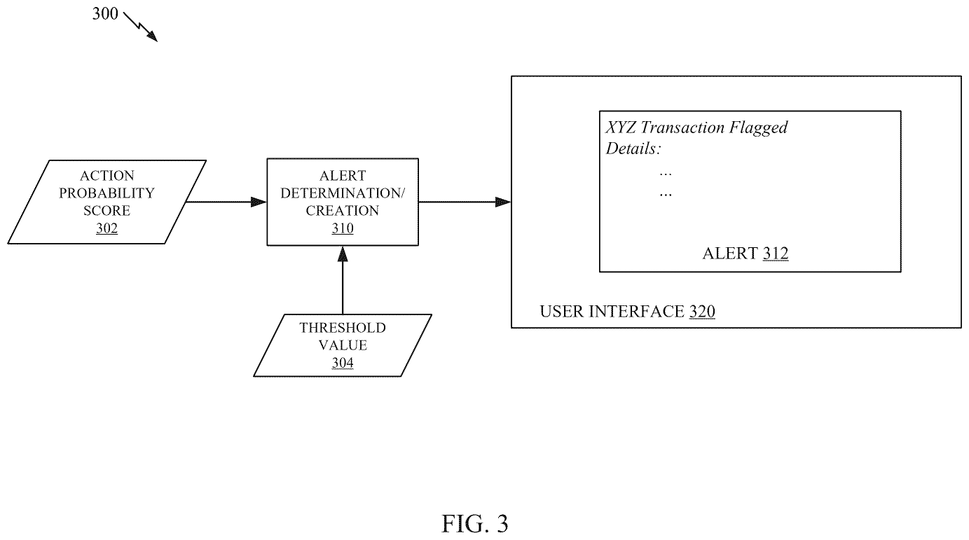

An output 232 may then be generated during output generation 230 based on the action probability scores 222. For example, if an action probability score for a particular group exceeds a threshold value, an alert may be created for that group (e.g., warning that the group is likely the target of coordinated fraud and flagging it for further review and/or action). Further action may be performed based on the output 232 such as displaying the output via a user interface or sending the output to one or more elements of a software application, as described in more detail below with respect to FIG. 3.

FIG. 3 depicts a block diagram 300 illustrating an example related to automatically detecting and classifying anomalies using machine learning models. For example, block diagram 300 may represent post-processing of the output generated by one or more steps described with respect to FIG. 1 and/or FIG. 2 and displayed on a user interface 320 (e.g., associated with a computing application running on a computing device).

After an action probability score 302 is calculated for a group of groups 122, the action probability score 302 may be compared to a threshold value 304 during alert determination/creation 310. The threshold value 304 may be provided to alert determination/creation 310 by manual input or may be generated (i.e., based on one or more inputs) by a machine learning model and provided to alert determination/creation 310. If the action probability score 302 is greater than the threshold value 304, an alert 312 may be generated and displayed on a user interface 320. The alert 312 may comprise a statement that the particular group was flagged, along with other information pertaining to the group, such as transaction details, account details, where and/or when the fraud is occurring or has occurred, and/or the like. Alert determination/creation 310 may also be configured to generate a list of all the action probability scores 222 (i.e., for every group) automatically ranked by risk level. Based on the alert 312 or the ranked list of scores, a support technician may be able to perform one or more actions, including reviewing the flagged groups, securing accounts, identifying the fraudulent actors, retrieving comprised information, and/or the like. In some embodiments, one or more other actions may be taken based on action probability score 302 being greater than the threshold value 304, such as automatically blocking or delaying a transaction (e.g., a transaction associated with action probability score 302, a different future transaction that shares one or more attributes with the transaction associated with action probability score 302, and/or the like).

### Example Operations Related to Automatically Detecting and Classifying Anomalies Using Machine Learning Models

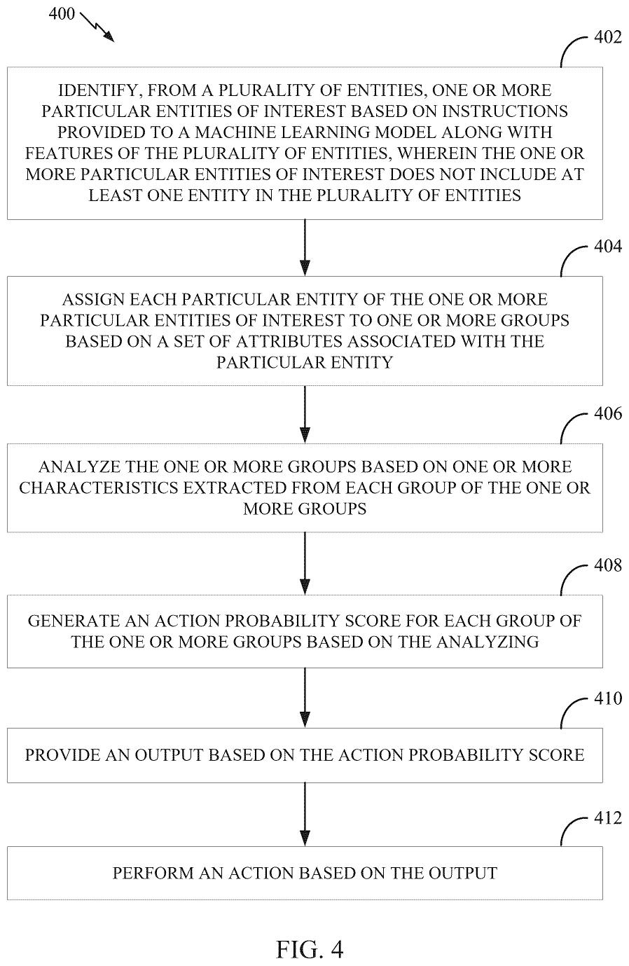

FIG. 4 depicts example operations 400 related to automatically detecting and classifying anomalies using machine learning models. For example, operations 400 may be performed by one or more of the components described with respect to FIG. 1, FIG. 2, and/or FIG. 3.

Operations 400 begin at step 402 with identifying, from a plurality of entities, one or more particular entities of interest based on instructions provided to a machine learning model along with features of the plurality of entities, wherein the one or more particular entities of interest does not include at least one entity in the plurality of entities. In certain embodiments, the entities comprise one or more of: one or more transactions; one or more accounts; or one or more merchants. In other embodiments, the features of the plurality of entities include: one or more transaction level features; and one or more account level features based on multiple transactions associated with an account. According to some embodiments, the identifying of the one or more particular entities of interest based on the instructions provided to the machine learning model comprises one or more of: flagging the one or more particular entities of interest using a model trained on labeled training data, using a supervised learning process, to detect entities in the plurality of entities with one or more features associated with labels in the labeled training data; or flagging the one or more particular entities of interest using a model trained on unlabeled training data using an unsupervised learning process to detect entities in the plurality of entities greater than a threshold distance from a baseline set of entities.

Operations 400 continue at step 404 with assigning each particular entity of the one or more particular entities of interest to one or more groups based on a set of attributes associated with the particular entity. Certain embodiments provide that the assigning of each particular entity of the one or more particular entities of interest to the one or more groups based on the set of attributes associated with the particular entities comprises one or more of: a graph-based clustering algorithm; or a distance-based clustering algorithm.

Operations 400 continue at step 406 with analyzing the one or more groups based on one or more characteristics extracted from each group of the one or more groups. In some embodiments, the characteristics comprise historical data associated with the one or more groups.

Operations 400 continue at step 408 with generating an action probability score for each group of the one or more groups based on the analyzing.

Operations 400 continue at step 410 with providing an output based on the action probability score. Some embodiments provide that the providing the output based on the action probability score comprises generating an alert if the action probability score exceeds a threshold value.

Operations 400 continue at step 412 with performing an action based on the output. According to certain embodiments, the performing of the action based on the output comprises one or more of: displaying the output via a user interface; or sending the output to one or more elements of a software application.

### Example of a Processing System for Automatically Detecting and Classifying Anomalies Using Machine Learning Models

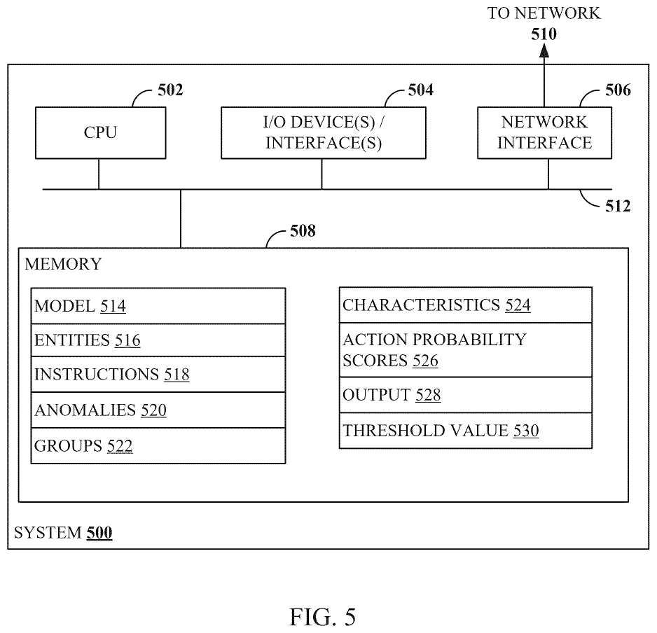

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, or FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 408, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes model 514, entities 516, instructions 518, anomalies 520, and groups 522. Model 514 may be representative of model 110 of FIG. 1. Entities 516 may be representative of entities 102 of FIG. 1. Instructions 518 may be representative of instructions 104 of FIG. 1. Anomalies 520 may be representative of anomalies 112 of FIG. 1. Groups 522 may be representative of groups 122 of FIG. 1 and FIG. 2.

Memory 508 further comprises characteristics 524 which may correspond to characteristics 212 of FIG. 2. Memory 508 further comprises action probability scores 526, which may correspond to action probability scores 222 of FIG. 2 and action probability score 302 of FIG. 3. Memory 508 further comprises output 528, which may correspond to output 232 of FIG. 2. Memory 508 further comprises threshold value 530, which may correspond to threshold value 304 of FIG. 3. It is noted that in some embodiments, system 500 may interact with one or more external components, such as via network 510, in order to retrieve data and/or perform operations. Furthermore, techniques described herein may be implemented via more or fewer components than those shown and described with respect to FIG. 5, such as on one or more computing systems.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for automatically detecting and classifying anomalies using machine learning models, comprising:
identifying, from a plurality of entities, one or more particular entities of interest based on instructions provided to a machine learning model along with features of the plurality of entities, wherein the one or more particular entities of interest does not include at least one entity in the plurality of entities;
assigning each particular entity of the one or more particular entities of interest to one or more groups based on a set of attributes associated with the particular entity, wherein the one or more groups contain only susceptible entities;
analyzing, using less computing resources as a result of the one or more groups containing only susceptible entities, the one or more groups based on one or more characteristics extracted from each group of the one or more groups;
generating an action probability score for each group of the one or more groups based on the analyzing;
providing an output based on the action probability score, wherein the providing the output comprises generating an alert flagging a group of the one of more groups if the action probability score corresponding to the group exceeds a threshold value and displaying the alert via a user interface; and
performing an action based on the output, wherein the performing the action comprises blocking a transaction associated with the action probability score corresponding to the group and one or more future transactions that share attributes with the transaction.

2. The method of claim 1, wherein the entities comprise one or more of:
one or more transactions;
one or more accounts; or
one or more merchants.

3. The method of claim 2, wherein the features of the plurality of entities include:
one or more transaction level features; and
one or more account level features based on multiple transactions associated with an account.

4. The method of claim 1, wherein the identifying of the one or more particular entities of interest based on the instructions provided to the machine learning model comprises one or more of:
flagging the one or more particular entities of interest using a model trained on labeled training data, using a supervised learning process, to detect entities in the plurality of entities with one or more features associated with labels in the labeled training data; or
flagging the one or more particular entities of interest using a model trained on unlabeled training data, using an unsupervised learning process, to detect entities in the plurality of entities greater than a threshold distance from a baseline set of entities.

5. The method of claim 1, wherein the assigning of each particular entity of the one or more particular entities of interest to the one or more groups based on the set of attributes associated with the particular entities comprises one or more of:
a graph-based clustering algorithm; or
a distance-based clustering algorithm.

6. The method of claim 1, wherein the characteristics comprise historical data associated with the one or more groups.

7. (canceled)

8. The method of claim 1, wherein the performing of the action based on the output further comprises sending the output to one or more elements of a software application.

9. A system for automatically detecting and classifying anomalies using machine learning models, comprising:
one or more processors; and
a memory comprising instructions that, when executed by the one or more processors, cause the system to:
identify, from a plurality of entities, one or more particular entities of interest based on instructions provided to a machine learning model along with features of the plurality of entities, wherein the one or more particular entities of interest does not include at least one entity in the plurality of entities;
assign each particular entity of the one or more particular entities of interest to one or more groups based on a set of attributes associated with the particular entity, wherein the one or more groups contain only susceptible entities;
analyze, using less computing resources as a result of the one or more groups containing only susceptible entities, the one or more groups based on one or more characteristics extracted from each group of the one or more groups;
generate an action probability score for each group of the one or more groups based on the analyzing;
provide an output based on the action probability score, wherein the providing the output comprises generating an alert flagging a group of the one of more groups if the action probability score corresponding to the group exceeds a threshold value and displaying the alert via a user interface; and
perform an action based on the output, wherein the performing the action comprises blocking a transaction associated with the action probability score corresponding to the group and one or more future transactions that share attributes with the transaction.

10. The system of claim 9, wherein the entities comprise one or more of:
one or more transactions;
one or more accounts; or
one or more merchants.

11. The system of claim 10, wherein the features of the plurality of entities include:
one or more transaction level features; and
one or more account level features based on multiple transactions associated with an account.

12. The system of claim 9, wherein the identifying of the one or more particular entities of interest based on the instructions provided to the machine learning model comprises one or more of:
flagging the one or more particular entities of interest using a model trained on labeled training data, using a supervised learning process, to detect entities in the plurality of entities with one or more features associated with labels in the labeled training data; or
flagging the one or more particular entities of interest using a model trained on unlabeled training data, using an unsupervised learning process, to detect entities in the plurality of entities greater than a threshold distance from a baseline set of entities.

13. The system of claim 9, wherein the assigning of each particular entity of the one or more particular entities of interest to the one or more groups based on the set of attributes associated with the particular entities comprises one or more of:
a graph-based clustering algorithm; or
a distance-based clustering algorithm.

14. The system of claim 9, wherein the characteristics comprise historical data associated with the one or more groups.

15. (canceled)

16. A non-transitory computer readable medium comprising instructions that, when executed by one or more processors of a computing system, cause the computing system to:
identify, from a plurality of entities, one or more particular entities of interest based on instructions provided to a machine learning model along with features of the plurality of entities, wherein the one or more particular entities of interest does not include at least one entity in the plurality of entities;
assign each particular entity of the one or more particular entities of interest to one or more groups based on a set of attributes associated with the particular entity, wherein the one or more groups contain only susceptible entities;
analyze, using less computing resources as a result of the one or more groups containing only susceptible entities, the one or more groups based on one or more characteristics extracted from each group of the one or more groups;
generate an action probability score for each group of the one or more groups based on the analyzing;
provide an output based on the action probability score, wherein the providing the output comprises generating an alert flagging a group of the one of more groups if the action probability score corresponding to the group exceeds a threshold value and displaying the alert via a user interface; and
perform an action based on the output, wherein the performing the action comprises blocking a transaction associated with the action probability score corresponding to the group and one or more future transactions that share attributes with the transaction.

17. The non-transitory computer readable medium of claim 16, wherein the entities comprise one or more of:
one or more transactions;
one or more accounts; or
one or more merchants.

18. The non-transitory computer readable medium of claim 17, wherein the features of the plurality of entities include:
one or more transaction level features; and
one or more account level features based on multiple transactions associated with an account.

19. The non-transitory computer readable medium of claim 16, wherein the identifying of the one or more particular entities of interest based on the instructions provided to the machine learning model comprises one or more of:
flagging the one or more particular entities of interest using a model trained on labeled training data, using a supervised learning process, to detect entities in the plurality of entities with one or more features associated with labels in the labeled training data; or
flagging the one or more particular entities of interest using a model trained on unlabeled training data, using an unsupervised learning process, to detect entities in the plurality of entities greater than a threshold distance from a baseline set of entities.

20. The non-transitory computer readable medium of claim 16, wherein the assigning of each particular entity of the one or more particular entities of interest to the one or more groups based on the set of attributes associated with the particular entities comprises one or more of:
a graph-based clustering algorithm; or
a distance-based clustering algorithm.
